(19) United States
(12) Patent Application Publication
(10) Pub. No.: US 2005/0087940 A1
(43) Pub. Date: Apr. 28, 2005

(54) Multi-functional wheel system

(76) Inventors: Emerson Ally, Brooklyn, NY (US); Rodney Harris, Bronx, NY (US)

Correspondence Address: Dwayne L. Bentley;LAW OFFICE OF DWAYNE L. BENTLEY, Suite 1112, 16 Court Street, Brooklyn, NY, 11241, US

(21) Appl. No.: 10/692,262

(22) Filed: Oct. 22, 2003

(51) Int. Cl. B62B 5/02

(52) U.S. Cl. 280/5.26

(57) ABSTRACT

The present invention provides a wheel system that includes a plurality of wheels and a base. The plurality of wheels are connected to the base, whereby the base has a plurality of curvature portions that provides for the easy maneuverability of the plurality of wheels.

This invention relates to a multi-functional wheel system provided for the movement of any type of vehicle and the like.

### BACKGROUND OF THE INVENTION

Typically, people utilize mobile vehicles, such as portable shopping carts, strollers, baby carriages etc. that have typical wheels to transport food items, products and children from one point to another. During this transportation, the person controlling the movement of the mobile vehicles experiences some difficulty traversing an ascending, descending, bumpy or rough surface. The wheels of these vehicles are equipped to deal with the wear and tear of transporting food items, but the person may not be able to deal with the strain of having to pull or push the vehicle.

In order to address the difficulty of pulling or pushing a vehicle, wheel assemblies were developed to aid a person in traversing various surfaces. Even though these wheel assemblies were able to assist the person in traversing the surfaces, the construction of the assemblies still caused the person to experience injury while pulling or pushing the vehicles. In addition, these wheel assemblies required the person to exert a lot of energy to move the vehicle over the surface.

Therefore, there is a need for a device that allows a user to effortlessly traverse any type of surface by utilizing less energy and experiencing less strain.

### BRIEF SUMMARY OF THE INVENTION

The present invention has been accomplished in view of the above-mentioned technical background, and it is an object of the present invention to provide a multi-functional wheel system that provides the user with an improved and simple device that is maneuverable along any type of surface.

In a first preferred embodiment, a wheel system includes a plurality of wheels and a base. The plurality of wheels are connected to the base, whereby the base has a plurality of curvature portions that provides for the easy maneuverability of the plurality of wheels.

In another preferred embodiment, a wheel system includes a plurality of wheels and a base. The plurality of wheels are connected to a base, whereby the base has a plurality of curvature portions coupled to the plurality of wheels. The plurality of curvature portions provides for the easy maneuverability of the plurality of wheels. The base has a center of gravity, whereby the center of gravity enables the plurality of wheels to be moved with less energy.

In yet another preferred embodiment, a system for using the wheel system is disclosed. A plurality of wheels are connected to a base, whereby the base has a plurality of curvature portions that provides the maneuverability of the plurality of wheels. A mobile vehicle is connected to the base.

In another embodiment, a method for using the multi-functional wheel system is disclosed. A movement of a mobile vehicle is initiated, where the mobile vehicle includes a wheel system that traverses across a surface. Weight of the mobile vehicle is transferred from one side of the mobile vehicle to the other side of the mobile vehicle. The mobile vehicle is pulled over the surface, then a plurality of curvature portions located on the wheel system are utilized to slide the wheel system and the mobile vehicle over the surface.

In yet another embodiment of the invention, a method for utilizing a wheel system is disclosed. Movement of a mobile vehicle having a wheel system is initiated to traverse across a surface. Weight of the mobile vehicle is transferred from one side of the mobile vehicle to another side of the mobile vehicle, then the mobile vehicle is pulled over the surface by utilizing a plurality of curvature portions on the wheel systems to easily slide the wheel system and the mobile vehicle. The wheel system includes a center of gravity that enables the wheel system to be moved with less energy.

### BRIEF DESCRIPTION OF SEVERAL VIEWS OF THE DRAWINGS

These and other advantages of the present invention will become more apparent as the following description is read in conjunction with the accompanying drawings, wherein:

FIG. 1 illustrates multi-functional wheel systems connected to a shopping cart in accordance with an embodiment of the invention;

FIGS. 2A-2F illustrate the utilization of the multi-functional wheel system of FIG. 1 in accordance with the invention;

FIG. 3 depicts the multi-functional wheel system of FIG. 1 in a retracted stated in accordance with the invention;

FIG. 4 depicts the multi-functional wheel system of FIG. 1 in a deployed stated in accordance with the invention;

FIG. 5 depicts a brake-lever detached from the multi-functional wheel system of FIG. 1 in accordance with the invention;

FIG. 6 depicts a cover detached from the multi-functional wheel system of FIG. 1 in accordance with the invention;

FIG. 7 depicts an inner portion of the multi-functional wheel system of FIG. 1 where its wheels are in a deployed state in accordance with the invention; and

FIG. 8 depicts the inner portion of the multi-functional wheel system of FIG. 1 where its wheels are in a retracted state in accordance with the invention;

FIG. 9 depicts the inner portion without the braking mechanism of FIG. 1 in accordance with the invention;

FIG. 10 depicts the entire multi-functional wheel system of FIG. 1 in accordance with the invention without the braking mechanism;

FIG. 11 is a flow chart of a method of manufacturing a multi-functional wheel system in accordance with the invention.

FIG. 12 illustrates the multi-functional wheel system of FIG. 1 in accordance with the invention whereby the wheel system utilizes three wheels instead of four wheels.

FIG. 13 illustrates the multi-functional wheel system of FIG. 1 in accordance with the invention whereby the wheel system utilizes five wheels instead of four wheels.

### DETAILED DESCRIPTION OF THE INVENTION

The presently preferred embodiments of the invention are described with references to the drawings, where like components are identified with the same numerals. The descriptions of the preferred embodiments are exemplary and are not intended to limit the scope of the invention.

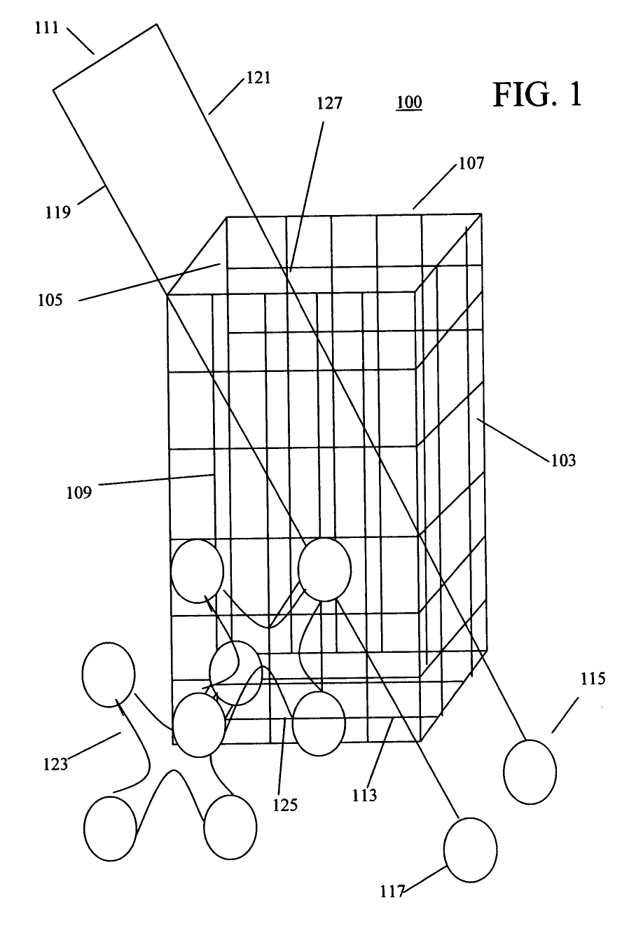

FIG. 1 illustrates multi-functional wheel systems connected to a mobile vehicle, such as a portable shopping cart. A standard shopping cart 100 includes a front wall 103, a back wall 105, a left side wall 107, a right wall 109, a handle 111, a bottom support wall 113, front wheels 115 and 117, right side extended shaft 119, a left side extended shaft 121, a basket 127 and multi-functional wheel systems 123 and 125. Walls 103, 105, 107, 109 and bottom support wall 113 are coupled to each other to form the basket 127. This typical basket 127 is supported by the bottom support section 113. Located at the left side and right side of the bottom support section 113 are extended shafts 119 and 121. A top portion of the shafts 119 and 121 are connected to the handle 111, which directs the forward, upward, downward and backward movement of shopping cart 100. In order for the cart 100 to be maneuvered, front wheels 115 and 117 are connected to a bottom portion of extended shafts 119, 121 and front wheels 115 and 117. In addition, a bottom portion of back wall 105 and bottom support wall 113 are connected to multi-functional wheel systems 123 and 125. Multi-functional wheel systems 123 and 125 are used instead of typical back wheels of a shopping cart in order to provide for the simple maneuverability of the cart 100. Even though a cart is utilized in connection with the multi-functional wheel systems 123 and 125, this cart may 100 be replaced with any type of device that utilizes wheels, such as a stroller, skateboard, bicycle, automobile, truck, scooter, luggage case, golf-cart, wheelchair etc. Further, the wheel systems 123 and 125 may be utilized as wheels for pianos, refrigerators, furniture etc. Also, the wheel systems 123 and 125 may be utilized in place of either or both wheels 115 and 117.

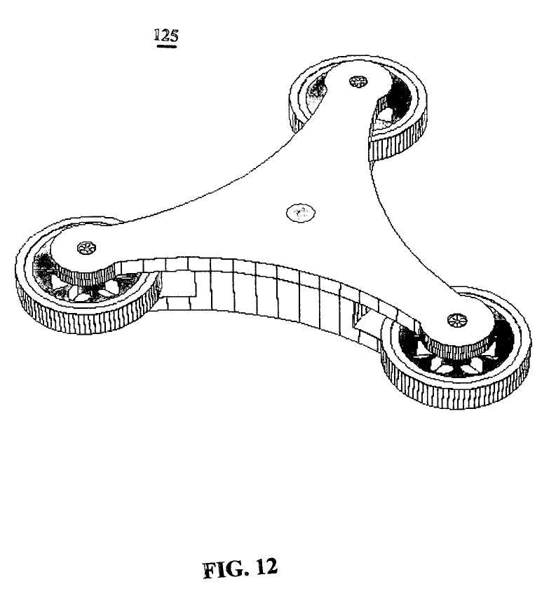

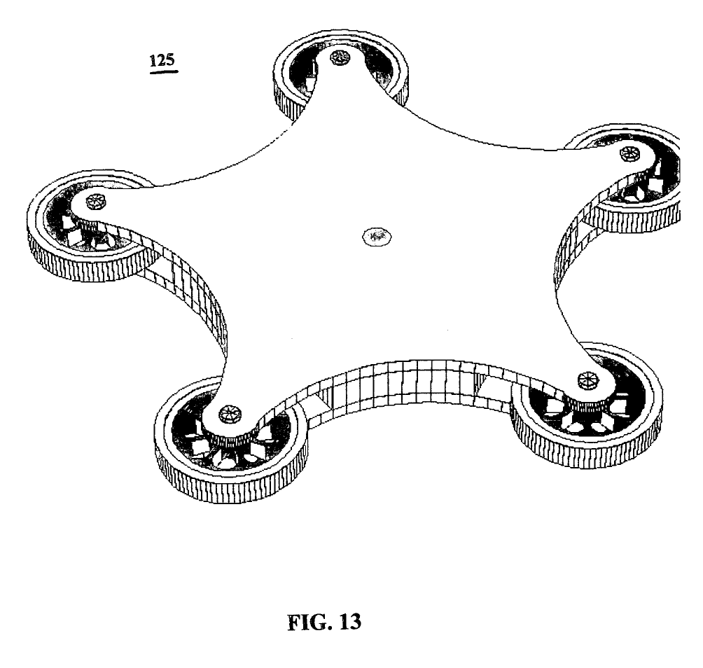

A mobile vehicle may utilize one, two, three, four or more wheel systems as shown in FIGS. 12 and 13. FIG. 12 illustrates the multifunctional wheel system of FIG. 1 whereby the wheel system utilizes three wheels instead of four wheels. Wheel system 125 of FIG. 12 includes all of the components of FIG. 1, which are not recited herein, except for the fourth wheel. FIG. 13 also illustrates the multi-functional wheel system of FIG. 1 whereby the wheel system utilizes five wheels instead of four wheels. Wheel system 125 of FIG. 13 includes all of the components of FIG. 1 that are not recited, but also includes the fifth wheel.

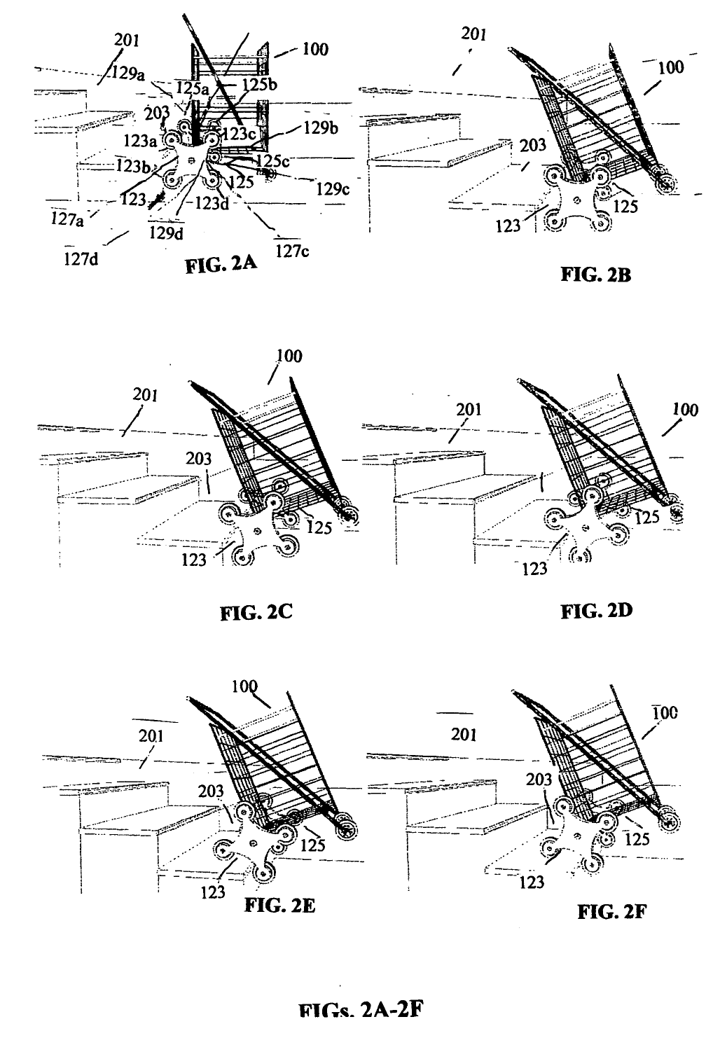

FIG. 2A illustrates shopping cart 100 in a fixed position, where front wheels 115 and 117 and wheel systems 123 and 125 are in a secure position on the ground in relation to stair 201. When the cart 100 is in this secure position its weight is delivered to front wheels 115 and 117 and wheel systems 123 and 125. Wheel systems 123 and 125 include a plurality of wheels 123a, 123b, 123c, 123d, 125a, 125b and 125c.

FIG. 2B illustrates the handle 111 being pulled backward, for example by a person (not shown), as the wheel systems 123 and 125 ascend a first step of stair 201. When the handle 111 is pulled back the front wheels 115 and 117 are lifted off the ground so the weight of the cart is shifted from being evenly distributed to the front wheels 115 and 117, multi-functional wheel systems 123 and 125 to distribute the weight only to the wheel systems 123 and 125.

In FIG. 2C handle 111 of cart 100 is utilized to pull cart 100 up step 203 of stair 201. As the cart 100 is pulled up step 203, multi-functional wheel systems 123 and 125 contacts step 203. As stated above, wheel systems 123 and 125 include wheels 123a and 125a, these wheels contact the step 203 as the cart 100 ascends it. Wheel systems 125 and 123 also include respective curvature portions 127a, 127b, 127c, 127d, 129a, 129b, 129c and 129d. The curvature portions 127a-d and 129a-d are adjacent to respective wheels 123a-d and 125a-d. Thus, when the wheels 125a and 123a contact the step 203 their respective curvature portions 127a and 129a also contacts step 203.

Curvature portions 127a-d and 129a-d are formed from an arc of an eleven-inch diameter circle, which is offset at six inches from a center of gravity of the wheel systems 123 and 125. The arc of the curvature portions 127a-d and 129a-d has an angle in the range of zero to seventy-five degrees. Preferably, the arc of the curvature portions 127a-d and 129a-d has an angle of forty-five degrees. The arc angle of curvature portions 127a-d and 129a-d enable the cart to be easily maneuverable to traverse or slide over any type of surface, such as a descending surface, ascending surface, bumpy surface, rough surface etc. When the curvature portion 127a and 129a contacts the step 203 of stair 201, these curvature portions assists in the ascension of the cart 100 up the stair. Curvature portions 127a and 129 aids in the ascension of cart 100 when the curvature portions 127a and 129a contacts step 203 at less than ninety degrees from a horizontal surface of the step 203. By enabling the cart 100 to contact the step 203 at less than ninety degrees the amount of energy required by a person to pull the cart 100 up stair 201 is reduced in comparison with the level or amount of energy required by a person to pull a typical cart back wheel up stair 201.

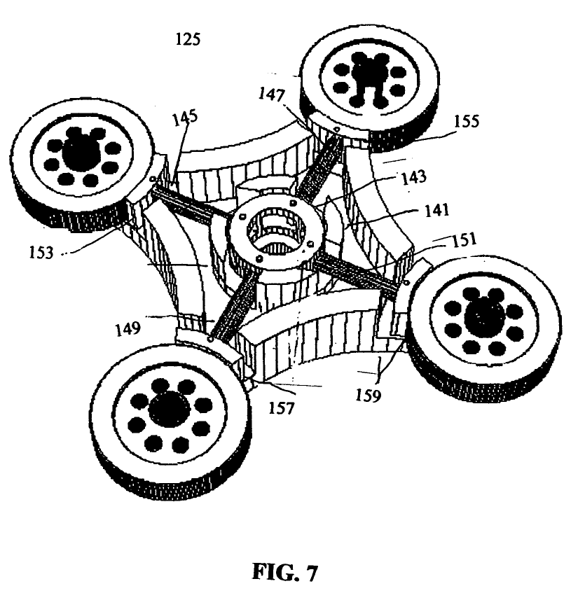

In addition, wheel systems 123 and 125 include the center of gravity that is higher up and farther out to the center, then the center of gravity for standard cartwheels or wheels. The center of gravity is located at 4.25 to 6 inch distance from at least one of the wheels 123a-d and 125a-d to the center of each respective wheel systems 123 and 125. Preferably, the center of gravity is located at a 6 inch distance from one of the wheels 123a-d and 125a-d to the center of the respective wheel systems 123 and 125. The distance of center of gravity to the wheels 123a-d and 125a-d is dependent on the weight of the wheels 123a-d, 125a-d and a rotating hub 143 (FIG. 7). If the weight of the wheels 123a and 125a-d are heavier than the weight of the rotating hub 143, then the distance between the center of gravity and the wheels 123a-d and 125a-d will be in the range of 4.25-5 inches. Otherwise, if the weight of the wheels 123a-d and 125a-d are lighter than the weight of the rotating hub 143, then the distance between the center of gravity and the wheels 123a-d and 125a-d will be in the range of 5-6 inches. By placing the center of gravity for the wheel systems 123 and 125 in the aforementioned location, wheel systems 123 and 125 require less energy for the cart 100 to traverse or slide over a surface, such as climbing step 203. Thus, in contrast to regular back cart wheels that require an upward force to ascend or climb step 203 when the wheels are locked in a corner of step 203, the multi-functional wheel systems 123 and 125 require less energy to move downward, upward, diagonally or any direction. For example, the wheel systems 123 and 125 require less energy to move cart 100 up the step 203.

FIG. 2D illustrates cart 100 ascending step 203. As cart 100 ascends step 203, a top portion of curvature portions 127a and 129a contacts step 203. When the top portion of curvature portions 127a and 129a contacts the step 203, the step 203 begins to slide or glide over the curvature portion so the cart can easily traverse the step 203. This simple sliding or gliding motion of the curvature portions 127a and 129a enables a person to pull the cart 100 upward over the step 203 with the person applying less energy than required to pull the typical cart 100 over the step 203.

FIG. 2E illustrates wheel systems 123 and 125 ascending step 203 to be on the horizontal surface of this step 203. At this point, the curvature portions 127a and 129a has enabled the wheel systems 123 and 125 to be on the horizontal surface of step 203.

FIG. 2F illustrates wheel systems 123 and 125 on the horizontal surface of step 203. The curvature portions 127a and 129a provide the means to easily move the wheel systems onto the step 203 so the cart 100 was simply maneuvered over the step 203 to a horizontal surface of step 203.

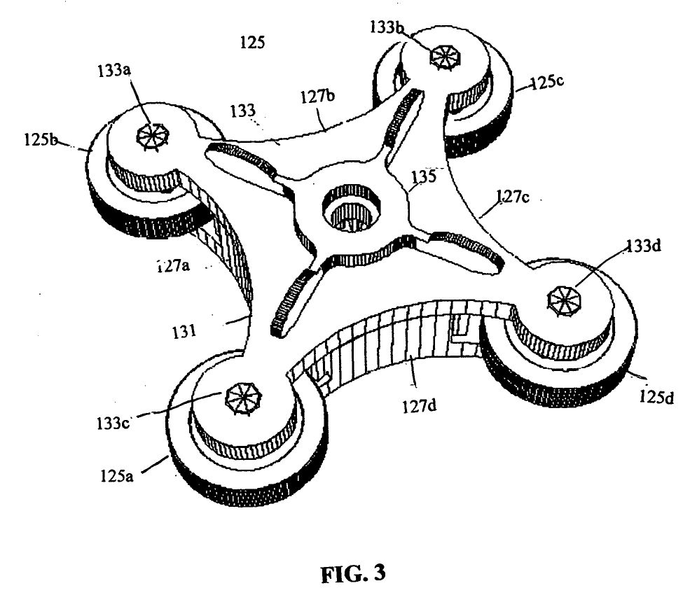

FIG. 3 depicts a brake lever of the multi-functional wheel system of FIG. 1 in a retracted state. Multi-functional wheel system 125 includes: wheels 125a-d, curvature portions 127a-d, base 131, cover 133, cover connector 133a-d and an optional brake-lever 135. Base 131 includes wheels 125a-d and curvature portions 127a-d. The multi-functional wheel system 125 may be made of a plastic, aluminum, steel or any type material known to those of ordinary skill in the art. Wheels 125a-d are made of plastic, rubber or any type of material known to those of ordinary skill in the art. Curvature portions 127a-d may be made of a plastic lacquer, such as polyurethane that reduces friction as these curvature portions make contact with a surface. The plastic lacquer has a tensile strength (TS) in the range of about 300-6000 TS. Tensile strength measures the resistance of a material to a force tending to tear it apart, measured as the maximum tension the material can withstand without tearing. In this example, a tensile strength of 300-1200 for the curvature portions 127a-d and 129a-d will be applicable for light applications, such as shopping carts. In another example, a tensile strength of 1000-3000 for the curvature portions 127a-d and 129a-d will be applicable for medium duty applications, such as golf-carts. In yet another example, a tensile strength of 2800-6000 for the curvature portions 127a-d and 129a-d will be applicable for heavy-duty applications. The different levels of tensile strength of the polyurethane on the curvature portions 127a-d and 129a-d reduces the friction between the curvature portions 127a-d and 129a-d and a surface, so the curvature portions 127a-d and 129a-d easily glides over a surface.

The curvature portions 127a-d may also have indentations to reduce friction as the curvature portions traverse a surface. In addition, the curvature portions may be a dip that can be moved or adhere to the base 131. Base 131, cover 133 and optional brake lever 135 may be made of plastic, steel, aluminum etc. Any type of adhesive, such as glue is placed on top of rotating hub 143 (FIG. 7) to force the base 131 and cover 133 to form the multi-functional wheel system 125. Cover connectors 133a-d connects the base 131 to the cover 133 as the brake lever 135 forces the base 131 to interact with the cover 133. The cover connectors 133a-d are typical connectors, such as screws that fastens or secures one device to another device. In addition, cover connectors may be female and male connectors located on the cover 131 and the base 133 that are interlocked together when these components are pressed together. Further, the cover connectors 133a-d may be located in the center of the curvature portions 127a-d to screw the cover 131 into openings in base 133. Also, brake lever 135 acts as a brake that automatically prevents the multi-functional wheel system 125 from moving in any direction. Multi-functional wheel system 123 includes the equivalent components as multi-functional wheel system 125.

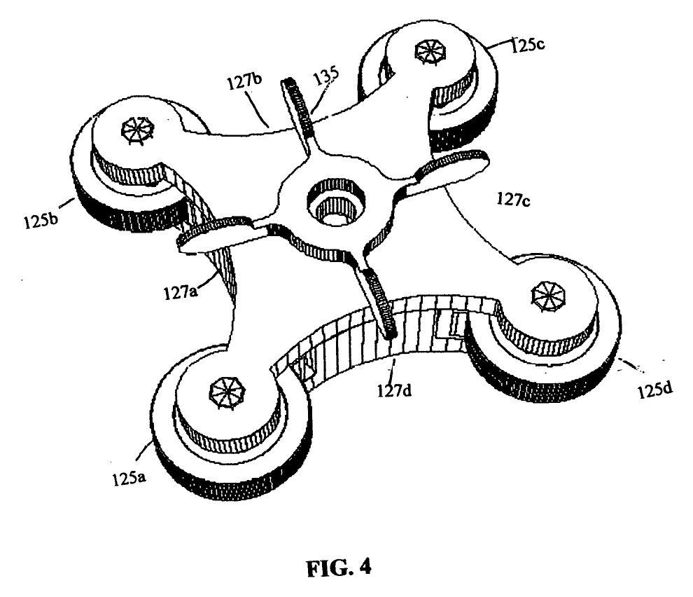

FIG. 4 depicts the brake lever of the multi-functional wheel system of FIG. 1 in a deployed state. This FIG. 4 is equivalent to FIG. 3 so a recitation of the components of FIG. 4 is not included herein. Brake lever 135 is in a deployed state, where the cover 135 is pressed into the base 131 to form the multi-functional wheel system 125.

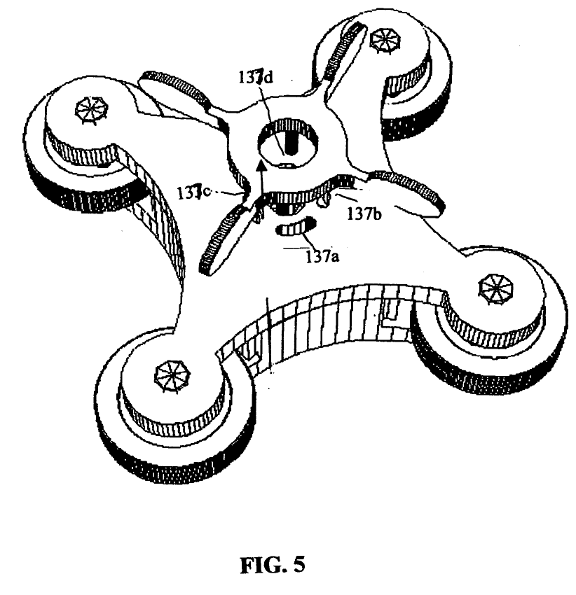

FIG. 5 depicts a brake lever detached from the multi-functional wheel system of FIG. 1. This FIG. 5 is equivalent to FIG. 3 so a recitation of the components of FIG. 5 is not necessary. However, FIG. 5 also includes a y openings 137a, 137b and 137 in cover 133, where the brake lever 135 will be inserted into the openings 137a-c. Brake lever 135 includes a bottom portion that has prongs or shafts that are inserted into the openings 137a-c. Openings 137a-c are conformed to the dimensions of the optional brake lever 135. The openings 137a-c have a width of approximately 0.25 inch to 0.50 inches. Preferably, the openings have a width of approximately 0.375 inches.

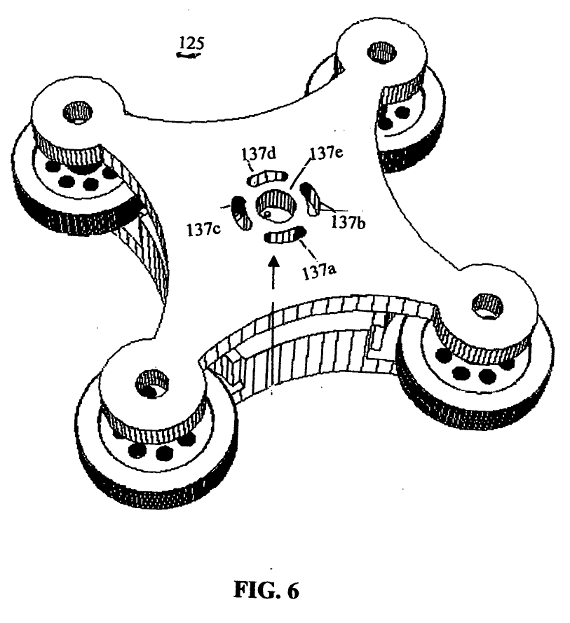

FIG. 6 depicts the cover detached from the multi-functional wheel system of FIG. 1. This FIG. 6 is equivalent to FIG. 3 so a recitation of the components of FIG. 6 will not be recited herein. Cover 133 includes openings 137a, 137b and 137c, as stated above, but it also includes openings 137d and 137e, which are conformed to receive prongs or shafts of the brake lever 135. The size of the openings is structured to allow the prongs of the brake lever 135 to fit through them.

FIG. 7 depicts an inner portion of the multi-functional wheel system of FIG. 1 where the wheels are in a deployed state. Multi-functional wheel system 125, as stated above, includes: wheels 125a-d, curvature portions 127a-d and an inner portion 139. Inner portion 139 includes: a brake core 141, a rotating hub 143, a shaft 145, a shaft 147, a shaft 149, a shaft 151, a brake pad 153, a brake pad 155, a brake pad 157 and a brake pad 159. The components of inner portion 139 and the brake lever 135 compose a braking mechanism for the wheel system 125. All the components of the inner portion 139, such as the brake core 141 may be made of plastic, aluminum, steel or any material known to those of ordinary skill in the art. Brake core 141 is a circular device that includes the rotating hub 143 and it also includes openings that allow the rotating hub 143 to connect and interact with the shafts 145-151. Shafts 145-151 are in dose proximity to the brake pads 153-159, approximately 0.25 to 0.50 inches. to enable them to contact the wheels 125a-d to prevent the movement of these wheels. In this example, the rotating hub 143 is in a deployed state in a clockwise direction of ninety degrees to enable the shafts 145-151 to contact the brake pads 153 159 that prevents the movement of wheels 125a-d. Optionally, the braking mechanism may include compression springs in place of the shafts 145-151, where these springs upon interaction with the rotating hub 143 will be retracted and/or released to contact the brake pads to prevent or allow the movement of wheels 125a-d. The clockwise or counterclockwise rotation or direction of rotating hub 143 controls the movement of the compression springs. Additionally, the brake lever 135 may be connected to a shaft (not shown) coupled to the handle 111, where a person can use this shaft to activate the braking mechanism to prevent the movement of wheel systems 123 and 125.

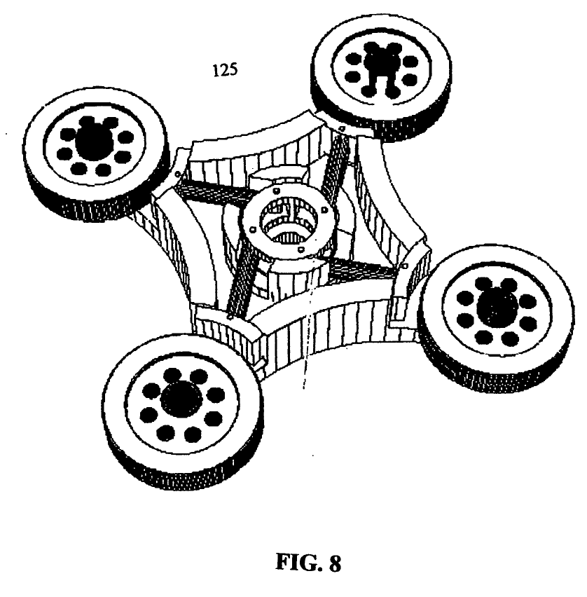

FIG. 8 depicts the inner portion of the multi-functional wheel system of FIG. 1 where its wheels are in a retracted state. This FIG. 8 is equivalent to FIG. 7 so a recitation of the components of FIG. 8 will not be recited herein. Rotating hub 143 is rotated in a counter-clockwise motion or sixty degrees that retracts the shafts 145-151, where the brake pads 153-159 are retracted so they do not touch and inhibit the movement of wheels 125a-d.

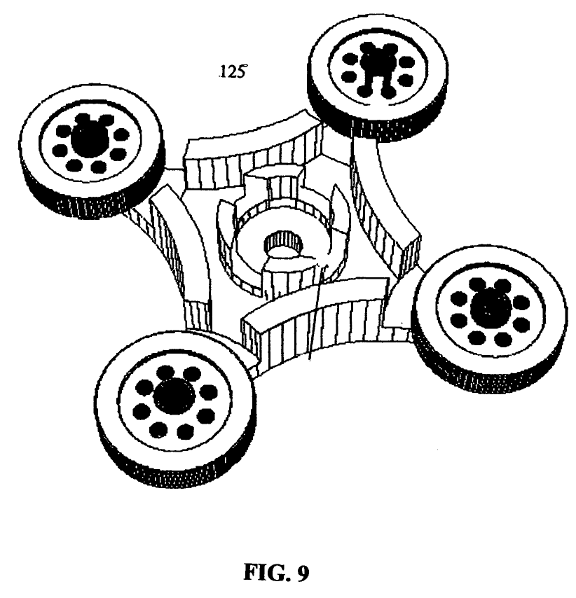

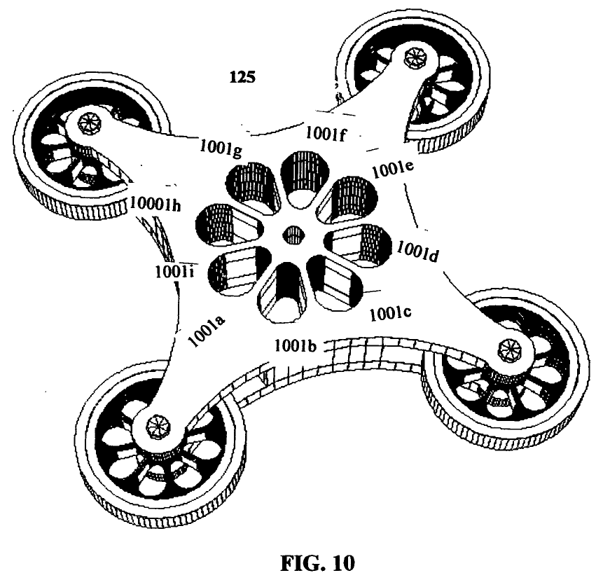

FIG. 9 depicts the inner portion without the braking mechanism of the rotating hub, shafts and the brake pads. In this depiction of the inner portion 139, there is no braking mechanism so the wheel system 125 can continuously turn as this wheel is deployed. FIG. 10 illustrates the entire multi-functional wheel system without the braking system. In this depiction of the wheel system 125, the cover 133 includes a plurality of openings 1001a-i to provide for the fluid movement of the wheel system 125 as it traverses a surface.

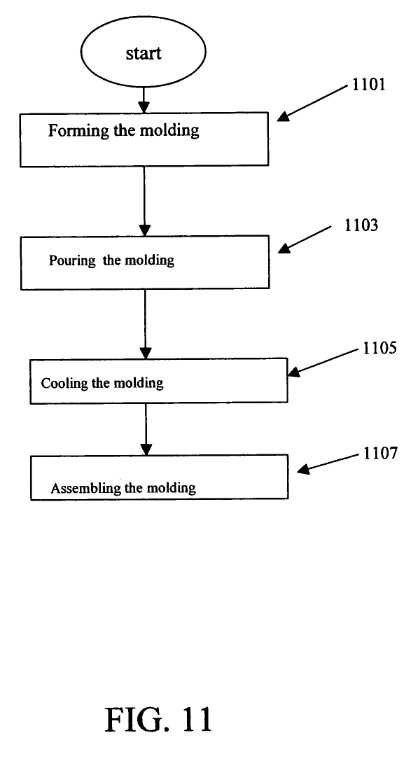

FIG. 11 is a flow chart of a method of manufacturing a multi functional wheel system of FIG. 1 in accordance with the invention. At 1101, a mold is formed for the multi functional wheel system 125. The mold is formed by a typical plastic injection molding, wood method molding or laser method molding process. Base 131 is formed with all of the components, described above, by the plastic molding, then the cover 133 molding with its associated components are then formed.

At 1103, after the molding for the base 131 and cover 133 are formed, then the materials utilized for the molding, such as plastic, steel, aluminum etc is poured in the molding. At 1105, the materials in the molding are cooled, then, at 1007, the base 131 and cover 131 are assembled or fitted together to form the multi-functional wheel system 125. As stated above, curvature portions 127a-d and 129a-d are formed from an arc of an eleven-inch diameter circle, which is offset at six inches from a center of gravity of the wheel systems 123 and 125.

This invention provides a simple means to allow a person to maneuver a cart or any other device that utilizes wheels. The wheel systems attached to the cart allows a user to simply glide the cart across any type of surface. Less energy is required by the user to move the cart as compared with the standard wheels of a cart.

It is intended that the foregoing detailed description be regarded as illustrative rather than limiting and that it be understood that it is the following claims, including all equivalents, which are intended to define the scope of the invention.

1. A wheel system comprising:
a plurality of wheels; and
said plurality of wheels connected to a base, wherein the base has a plurality of curvature portions that provides for the easy maneuverability of the plurality of wheels.

2. The wheel system of claim 1, wherein the plurality of curvature portions comprises a tensile strength in a range of about 300-6000 TS.

3. The wheel system of claim 2, wherein the tensile strength of the plurality of curvature portions is in the range of about 300-1200 TS.

4. The wheel system of claim 2, wherein the tensile strength of the plurality of curvature portions is in the range of about 1000-3000 TS.

5. The wheel system of claim 1, wherein the plurality of wheels comprises two wheels.

6. The wheel system of claim 1, wherein the plurality of wheels comprises three wheels.

7. The wheel system of claim 1, wherein the plurality of wheels comprises four wheels.

8. The wheel system of claim 1, wherein the plurality of curvature portions comprise an arc from an eleven-inch diameter circle.

9. The wheel system of claim 9, wherein the arc of the plurality of curvature portions comprises an angle in a range of about zero to seventy-five degrees.

10. The wheel system of claim 9, wherein the angle comprises forty-five degrees.

11. A wheel system comprising:
a plurality of wheels;
said plurality of wheels connected to a base, wherein the base has a plurality of curvature portions coupled to the plurality of wheels, wherein the plurality of curvature portions provides for the easy maneuverability of the plurality of wheels; and
the base having a center of gravity, wherein the center of gravity enables the plurality of wheels to be moved with less energy.

12. The wheel system of claim 11, wherein a distance of the center of gravity to the plurality of the wheels is in the range of about 4.25-6 inches.

13. The wheel system of claim 12, wherein the distance of the center of gravity to the plurality of the wheels comprises 6 inches.

14. A system for utilizing a wheel system comprising:
a plurality of wheels;
said plurality of wheels connected to a base, wherein the base has a plurality of curvature portions that provides the maneuverability of the plurality of wheels; and
a mobile vehicle connected to the base.

15. The system of claim 14, wherein the mobile vehicle is a cart.

16. The system of claim 14, wherein the mobile vehicle is a stroller.

17. The system of claim 14, wherein the mobile vehicle is a scooter.

18. A method for utilizing a wheel system, comprising:
initiating movement of a mobile vehicle, having a wheel system across, a surface;
transferring weight from one side of the mobile vehicle to another side of the mobile vehicle;
pulling the mobile vehicle over the surface; and
sliding the wheel system and the mobile vehicle over the surface by utilizing a plurality of curvature portions on the wheel system.

19. The method of claim 18, forming the plurality of curvature portions from an arc of a circle, wherein the arc comprises an angle in the range of about zero to seventy-five degrees.

20. The method of claim 19, wherein the arc of the plurality of curvature portions comprises the angle of forty-five degrees.

21. The method of claim 16, wherein sliding the wheel system and the mobile vehicle across the surface comprises gliding the wheel system and mobile vehicle.

22. A method for utilizing a wheel system, comprising:
initiating movement of a mobile vehicle having a wheel system across a surface;
transferring weight from one side of the mobile vehicle to another side of the mobile vehicle;
pulling the mobile vehicle over the surface; and
sliding the wheel system and the mobile vehicle over the surface by utilizing a plurality of curvature portions, wherein the wheel system includes a center of gravity that enables the mobile vehicle to be simply moved with less energy.

23. A method of manufacturing a multi-functional wheel system, comprising:
forming a mold for the multi-functional wheel system;
pouring a material into the mold; and
assembling the multi-functional wheel system.

24. The method of claim 23, wherein forming the mold comprises forming a base and a cover for the multi-functional wheel system.
